(19) United States
(12) Patent Application Publication
(10) Pub. No.: US 2026/0054292 A1
(43) Pub. Date: Feb. 26, 2026

(54) METHOD AND SYSTEM FOR ADDRESSING BUILDUP ON PRINTER CUTTING ELEMENTS

(71) Applicant: KICTeam, Inc., Auburn, ME (US)

(72) Inventors: John Condon, Sumner, ME (US); Kenneth Pedersen, Auburn, ME (US); Christopher Hudnor, Auburn, ME (US)

(21) Appl. No.: 19/308,731

(22) Filed: Aug. 25, 2025

Related U.S. Application Data
(60) Provisional application No. 63/686,347, filed on Aug. 23, 2024.

(51) Int. Cl. B08B 1/40; B08B 1/14; B32B 27/06; B32B 27/12; B32B 27/30; B41J 3/407; B41J 11/70; B41J 29/17; C11D 17/04

(52) U.S. Cl. CPC B08B 1/40; B08B 1/14; B41J 3/4075; B41J 11/70; B41J 29/17; C11D 17/049; B32B 27/06; B32B 27/12; B32B 27/304; B32B 2307/54; B32B 2307/7376; B32B 2432/00

(57) ABSTRACT

Methods for cleaning and/or coating a printer's cutting blade, and optionally other components of a cutting mechanism, in printers such as label printers. The method involves providing a substrate made of porous material treated with a treatment solution, inserting the substrate into the printer's transport path, and activating the printer to extend and retract the cutting blade to contact the substrate. This process removes and/or reduces adhesive buildup, thereby prolonging the printer's operational efficiency. Various embodiments include pre-saturated substrates, multi-layer substrates with absorbent and abrasive layers, and heated substrates for enhanced cleaning. This method simplifies maintenance, reduces printer downtime, and helps to ensure consistent printing quality.

### RELATED APPLICATIONS AND CLAIM OF PRIORITY

This patent document claims priority to U.S. Provisional Patent Application No. 63/686,347, filed Aug. 23, 2024, the disclosure of which is fully incorporated into this document by reference.

### TECHNICAL FIELD

This disclosure pertains to the field of maintenance and cleaning methods for maintenance of printers. The disclosure more specifically relates to methods for cleaning and/or reducing buildup of residue on the cutting blade and/or cutting block of a printer such as a label printer or other thermal printer.

### BACKGROUND

Label printers are indispensable in various sectors, such as retail, logistics, manufacturing, and food services. These printers produce adhesive labels that are attached to products, packages, or containers, conveying important information like pricing, barcodes, and product details. Given their frequent and intensive use, maintaining these printers in optimal working condition is essential. Proper maintenance of label printers is crucial to ensure their efficient operation and longevity, particularly in high-demand environments where printer downtime can significantly disrupt operations.

A significant challenge in maintaining label printers is managing the adhesive residue that accumulates on the cutting blades or the cutting blade and the cutting block over time. This residue can be even more of an issue in linerless label printers, which have an uncovered (i.e., exposed) side that is coated with adhesive. The buildup of adhesive on the cutting components of label printers causes several operational problems. The sticky residue can dull the cutting blade, reducing its effectiveness and resulting in jagged or incomplete cuts. This can lead to label jams within the printer, causing downtime and necessitating manual intervention to resolve. Moreover, the adhesive can spread to other parts of the printer, further complicating the cleaning and maintenance process.

Existing solutions for cleaning label printers are often inadequate and inconvenient. Traditional cleaning methods for label printers require disassembling the printer to access the cutting blade and cutting block, which is labor-intensive and often requires technical expertise. Manual cleaning with solvents and swabs involves removing printer components, which is not only time-consuming but also risks damaging delicate parts. Some methods use silicone sprays to prevent adhesive buildup, but these sprays can be messy and are not always effective in providing long-term protection. Additionally, silicone-based solutions can contaminate the labels and interfere with subsequent printing processes.

Similar issues arise in printers that use cutting elements to cut print substrates that are not labels, such as the cutting elements in thermal printers that are used for receipts, ticket printing, and the like.

There is a clear need for a more efficient and user-friendly printer cleaning and maintenance method. An ideal solution would simplify the cleaning process, reduce maintenance time, and extend the operational lifespan of the printer's cutting components. Such a solution should not require printer disassembly and should be easy to use, even for individuals without technical expertise.

### SUMMARY

This disclosure aims to provide an effective, user-friendly solution to treat and/or clean the cutting elements of a printer without requiring disassembly, thereby improving the overall reliability and performance of the printer. The disclosure provides a method for cleaning a printer that involves using a substrate made of a porous material treated with a treatment solution that is a cleaning and/or coating solution. The substrate is inserted into the transport path of the printer. The printer is then activated to extend the cutting blade(s) (and optionally a cutting block) from their retracted positions into a cutting position, where they contact the substrate. The cutting blade also may form a cut into the substrate. This contact allows the solution to interact with the cutting blade and cutting block. After this, the cutting blade and (optionally) cutting block retract, leaving at least a portion of the solution in contact with them. This process can help to clean residue from the cutting blade and (if used) cutting block, reduce adhesive buildup on those elements, or both, thus helping to prolong the operational efficiency of the printer.

In some embodiments, a method of cleaning or coating cutting elements of a printer includes providing a substrate comprising a porous material treated with a cleaning and/or coating solution, inserting the substrate into a transport path of a printer, and activating the printer to cause a cutting blade (and optionally a cutting block) to extend from a retracted position to a cutting position in which the cutting blade and (optionally) the cutting block contact the substrate, so that the solution contacts the cutting blade and (optionally) the cutting block. The blade and block then retract from the substrate, wherein at least a portion of the solution remains in contact with the cutting blade and (if used) the cutting block after the retraction.

In some embodiments, before inserting the substrate into the transport path, the substrate may be treated with the solution by spraying the solution on the substrate, soaking the substrate in the solution, or applying the solution to the substrate by a coating method. The method may further comprise activating the printer to cause the cutting blade to extend into the substrate and retract from the substrate more than one time. Additionally, the printer may be activated to cause the cutting blade to extend into the substrate and retract from the substrate a plurality of times at multiple locations on the substrate while the substrate moves along the transport path.

In some embodiments, the substrate may comprise foam, polyethylene foam, polyurethane foam, cellulose tissue, non-cellulosic material, or felt. The treatment solution may comprise a lubricant or anti-adhesive agent to reduce buildup on the cutting blade and cutting block. The treatment solution may be free from silicone. The substrate may be pre-saturated with the cleaning and/or treatment solution and provided in a sealed pouch. Alternatively, the substrate and the treatment solution may be packaged separately, wherein the treatment solution is applied to the substrate immediately before use. The treatment solution may also be applied to the substrate using a spray bottle.

In some embodiments, the substrate may be positioned such that it contacts not only the cutting blade and cutting block but also another part of the printer that comes into contact with adhesive residues. When the treatment solution contacts the cutting blade and/or the cutting block, it may form a protective coating on the cutting blade and/or the cutting block, which prolongs the time before adhesive buildup occurs again. The substrate may comprise a multi-layer structure, including an absorbent layer to retain the treatment solution and a backing layer to provide structural support during the cleaning method. Alternatively, the substrate may comprise a multi-layer structure with an abrasive layer to help remove residues from the cutting blade and/or the cutting block.

In some embodiments, before the substrate is inserted into the printer, the substrate may be heated above ambient temperature of the environment in which the printer exists to enhance the cleaning effect of the treatment solution. The method may also include rotating the substrate within the transport path to expose various parts of the substrate to the cutting blade and cutting block. The printer may be a thermal printer such as a label printer. Additionally, the substrate may be secured in place within the transport path to ensure stability during the cutting process.

In some embodiments, a method of treating a printer comprises providing a first substrate comprising a porous material treated with a cleaning solution, inserting the first substrate into a transport path of the printer, and activating the printer to cause a cutting blade (and optionally a cutting block) to extend from a retracted position to a cutting position in which the cutting blade and (optionally) the cutting block contact the first substrate, so that the cleaning solution contacts the cutting blade and the cutting block. The cutting blade and (if used) cutting block then retract from the first substrate, which is then removed from the transport path. A second substrate comprising a porous material treated with a coating solution is provided and inserted into the transport path of the label printer. The label printer is activated to cause the cutting blade and (optionally) the cutting block to extend from a retracted position to a cutting position in which the cutting blade and (optionally) the cutting block contact the second substrate, so that the coating solution contacts the cutting blade and (optionally) cutting block to form a protective coating on the cutting blade and cutting block. The cutting blade and (if used) cutting block then retract from the second substrate, wherein at least a portion of the coating solution remains in contact with the cutting blade and/or the cutting block after the retraction. The cleaning solution and the coating solution may be the same solution, or they may be different solutions.

As discussed, the method and system may suitably include the use of a controller or processor.

### BRIEF DESCRIPTION OF THE DRAWINGS

The following figures and descriptions provide a detailed understanding of various embodiments of the present disclosure. The drawings illustrate the components and operation of a label printer, highlighting the positions and transitions of the cutting blade. These example embodiments are intended to aid in understanding the inventive concepts and are not to be construed as limiting the scope of the invention.

FIG. 1 is a schematic diagram illustrating a configuration of a printer such as a label printer according to an example embodiment of the present disclosure.

FIG. 2 is a diagram depicting the retracted position of a cutting blade, according to an example embodiment of the present disclosure.

FIG. 3 is a diagram illustrating the cutting position of a cutting blade, transitioned from the retracted position, according to an example embodiment of the present disclosure.

FIG. 4 is a diagram illustrating the retracted position of a cutting blade, transitioned from the cutting position, according to an example embodiment of the present disclosure.

FIG. 5 is a diagram illustrating various steps of a printer cutting element cleaning and/or treatment process, according to an example embodiment of the present disclosure.

FIGS. 6A-6D illustrate example elements of possible substrate structures.

FIG. 7 illustrates example elements of an alternate substrate shape.

### DETAILED DESCRIPTION

The following detailed description of various embodiments of the invention is provided to illustrate specific configurations and implementations. It is not intended to be exhaustive or to limit the invention to the precise forms disclosed. Numerous modifications and variations are possible in light of the following teachings. The embodiments were chosen and described in order to best explain the principles of the invention and its practical applications, thereby enabling others skilled in the art to understand the invention for various embodiments and with various modifications that are suited to the particular use contemplated.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. These terms are merely intended to distinguish one component from another component, and the terms do not limit the nature, sequence, or order of the constituent components. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

In the context of the present disclosure, the use of terms such as “may,” “might,” “can,” “could,” “would,” “should,” “suggest,” and similar language should be understood as being generally permissive, indicating that the actions or conditions described are within the scope of the invention, though not necessarily required.

The descriptions provided herein should not be construed as limiting but as an example. Various changes and modifications may be made without departing from the spirit and scope of the invention. The claims should be construed broadly to cover all such variations, modifications, and equivalents within the scope of the invention.

The present disclosure outlines a comprehensive method and system for cleaning the cutting elements of a printer using a substrate treated with a specialized cleaning and/or treatment solution. This innovative method is designed to be straightforward, highly effective, and adaptable, ensuring compatibility with a wide range of label printers. In various embodiments, the method can be used to treat the cutting elements of any thermal printer or other printer in which a cutting blade is used to cut a substrate, such as a roll that is used to print receipts, labels, tickets and the like. It encompasses both traditional label printers and modern linerless label printers, as well as printers capable of handling both traditional labels and linerless labels, thus providing a versatile solution for maintaining high-quality printer performance. By incorporating this method, users can achieve thorough cleaning of the cutting blade and cutting block, thereby enhancing the longevity and reliability of their printing equipment.

Traditional label printers utilize labels with a backing or liner that is peeled away before application. The process of removing these liners can leave behind adhesive residues on the cutting blade and cutting block, making regular cleaning essential to maintain optimal printer performance and prevent malfunctions. On the other hand, linerless label printers operate with labels that do not have a backing, posing distinct challenges. These challenges include adhesive from the labels themselves adhering directly to the cutting components. The absence of a liner in these printers can lead to more frequent and severe adhesive buildup on the cutting blade and cutting block. This buildup can cause potential jams, significantly reduce printing quality, and increase the need for maintenance. Consequently, an effective cleaning method will have benefits for both types of printers to ensure continuous, high-quality printing and to extend the lifespan of the equipment.

The primary elements of this innovative cleaning method may include a porous substrate material, a carefully formulated cleaning and/or treatment solution, and components of the printer's cutting mechanism, namely one or more cutting blade, and optionally one or more cutting blocks. By implementing this method, users may ensure thorough cleaning and maintenance of these vital printer parts, thereby enhancing the printer's overall performance and longevity. The method may address the specific challenges posed by both liner and linerless label printers, or other thermal printers, providing a versatile and robust solution for maintaining these essential devices.

The substrate may be made from a porous material that can absorb and retain the cleaning and/or treatment solution. Suitable materials for the substrate may include foam, polyethylene foam, polyurethane foam, cellulose tissue, non-cellulosic materials, or felt. The choice of material may depend on factors such as the type of printer, the nature of the residues to be cleaned, and the specific cleaning and/or treatment solution used. For instance, polyethylene foam and polyurethane foam may be preferred due to their durability and excellent absorption properties. Cellulose tissue may be advantageous for its biodegradability and ease of disposal.

The thickness of the foam substrate should be sufficient to ensure proper contact with the cutting mechanism components, allowing them to be fully, or at least substantially, coated with the cleaning and/or treatment solution as they cut through and retract. In some embodiments, the thickness of the foam may be at least equal to the thickness of the cutting blade, or possibly at least half the thickness of the cutting blade. In some embodiments, the foam may be up to a quarter of an inch thick. A thicker foam substrate may enable more contact time and better application of the solution to the blade(s) and other elements of the cutting mechanism, thereby improving the overall effectiveness of the cleaning and treatment process.

Additionally, the density and hardness of the foam may be important considerations to ensure effective shearing action. The substrate may be dense enough to withstand the shearing action of the cutting blade(s), ensuring that it cuts through the foam cleanly and uniformly. A foam that is too soft may not provide the necessary resistance, resulting in incomplete cleaning or treatment. Conversely, a foam that is too hard may not conform adequately to the shape of the cutting blade and cutting block, reducing the contact area and effectiveness. Thus, selecting a foam with the appropriate balance of density and hardness may be desirable for improved performance. This balance may ensure that the foam substrate can effectively engage with the cutting mechanism, allowing for thorough cleaning and treatment of the cutting blade(s) and cutting block, including the edges of the blade. Ensuring that the edges of the blade are adequately treated may be crucial, as these areas are prone to adhesive buildup and require effective cleaning to maintain the blade's sharpness and functionality.

The method described may include activating the printer to cause the cutting blade(s) to extend into the substrate and retract from the substrate more than one time. This repeated activation and retraction process can help ensure that the cleaning and/or treatment solution is thoroughly applied to the cutting blade(s), and optionally also the cutting block. By engaging the cutting blade(s) multiple times, the method enhances the removal of adhesive residues and debris that may be more stubborn or thickly accumulated on the cutting surfaces. The repeated motion allows the cleaning solution to penetrate and dissolve these residues more effectively, while also ensuring that the treatment solution forms a consistent and durable protective coating.

This method of multiple extensions and retractions may be particularly beneficial for label printers that experience heavy usage and significant adhesive buildup. By ensuring that the cutting blade(s) and cutting block are subjected to the cleaning and/or treatment solution multiple times, the method provides a more thorough maintenance routine. This approach can help maintain high quality performance of the label printer by reducing the frequency of manual cleaning and maintenance, thereby minimizing downtime and extending the lifespan of the printer components.

The multiple activation cycles may be controlled automatically by the printer's software or initiated manually by the user through a maintenance mode. This flexibility allows the cleaning process to be tailored to the specific needs of the printer and the extent of adhesive buildup. For example, in environments where printers are used continuously and accumulate significant adhesive residue, the printer can be programmed to activate the cutting blade and cutting block multiple times at regular intervals. In less demanding environments, fewer activation cycles may be sufficient to maintain cleanliness.

Furthermore, this process may include adjusting the timing and speed of the cutting blade movements to improve the cleaning and treatment effectiveness. Slower movements (i.e., movements that are slower than the printer's normal cutting duty cycle speed of movement) may allow more time for the cleaning solution to act on the residues, while faster cycles (i.e., movements that are faster than the printer's normal cutting duty cycle speed of movement) can help ensure that the treatment solution is evenly distributed across the cutting surfaces. In some embodiments, a relatively slower movement may be applied to at least a first extension and retraction cycle, while a relatively faster movement may be applied to at least a second extension and retraction cycle. This adaptable approach ensures that the cleaning and maintenance process is efficient and effective across a variety of operational conditions and printer models.

Overall, incorporating multiple extensions and retractions into the cleaning method provides a robust solution for maintaining printers that include cutting elements, removing or reducing adhesive buildup to help the printer operate at higher efficiency. This method can significantly reduce the need for frequent manual intervention, thereby enhancing the reliability and productivity of the printing operations.

The cleaning and/or treatment solution may include various substances, such as lubricants or anti-adhesive agents, to effectively reduce buildup on the cutting blade(s) and/or cutting block. In some embodiments, the cleaning and/or treatment solution may be free from silicone to avoid potential contamination or adverse reactions with the printer components. Commonly used lubricants in the solution may include water-based or oil-based lubricants that are safe for printer components. Anti-adhesive agents, such as Teflon or similar non-stick materials, may be included to prevent adhesives from sticking to the cutting surfaces. The cleaning and/or treatment solution may be one described in U.S. patent application Ser. No. 19/069,781, titled “Cleaning Product with Adhesive-Inhibiting Properties,” the disclosure of which is fully incorporated by reference herein. For example, as disclosed in that patent application, the cleaning and/or treatment solution may include ethanol and tripropylene glycol n-butyl ether (TGBE). In some embodiments, the cleaning and/or treatment solution may consist essentially of ethanol and TGBE. The TGBE may be present in an amount of about 50-65% by weight based on the total weight of the cleaning medium. The ethanol may be present in an amount of about 35-50% by weight based on the total weight of the cleaning and/or treatment solution. Optionally, the TGBE may be present in an amount of about 51% by weight and the ethanol may be present in an amount of about 49% by weight based on the total weight of the cleaning and/or treatment solution. Optionally, an amount of the TGBE may be more than an amount of the ethanol by weight.

The TGBE may include tripropylene glycol monobutyl ether, propylene glycol monobutyl ether, and/or and tripropylene glycol. The cleaning and/or treatment solution may further include dipropylene glycol n-butyl ether.

In some embodiments, the tripropylene glycol monobutyl ether may be present in an amount of more than about 95%, about 96%, about 97%, about 98%, or about 99% by weight based on a total weight of the tripropylene glycol monobutyl ether, propylene glycol monobutyl ether, tripropylene glycol, and/or dipropylene glycol n-butyl ether present in the solution. In some embodiments, except for tripropylene glycol monobutyl ether and ethanol, propylene glycol monobutyl ether may be the most contained chemical by weight in the solution. In some embodiments, the cleaning and/or treatment solution may be free or substantially free of limonene. In some embodiments, the cleaning and/or treatment solution may be free or substantially free of isopropyl alcohol (IPA). In some embodiments, the cleaning and/or treatment solution may be free or substantially free of dipropylene glycol methyl ether acetate. In some embodiments, the cleaning medium may be free or substantially free of silicone.

Additionally, solutions commonly used in similar fields, such as isopropyl alcohol or specialized printer cleaning fluids, may be effective in dissolving and removing adhesive residues. These solutions are known for their ability to evaporate quickly, leaving minimal residue, and for their compatibility with a wide range of materials used in printing equipment.

In some embodiments, the substrate may be treated with the cleaning and/or treatment solution by spraying, soaking, or applying the solution using a coating method. Coating methods such as roll coating, dip coating, or slot die coating may be used to help ensure even distribution of the cleaning and/or treatment solution across the substrate. For instance, in roll coating, the substrate may be passed through a series of rollers that apply an at least substantially uniform layer of the cleaning and/or treatment solution. In dip coating, the substrate may be submerged in a tank containing the cleaning and/or treatment solution, ensuring full saturation. Slot die coating may involve the controlled application of the cleaning and/or treatment solution through a precision die, providing consistent coverage.

In some embodiments, the method of treating a printer may involve a two-step process utilizing two different substrates treated with distinct solutions, with one used to clean the cutting elements and the second used to treat and coat the cutting elements. Initially, a first substrate comprising a porous material treated with a cleaning solution may be provided. This first substrate may be inserted into the transport path of the label printer. Upon activation, the printer's cutting blade(s), and optionally the cutting block, may extend from their retracted positions to a cutting position where they contact the first substrate. This contact may allow the cleaning solution to interact with the cutting blade and cutting block, effectively removing adhesive residues and debris. After the cleaning solution has adequately contacted the cutting components, the blade(s) (and optionally the block) may retract, and the first substrate may be subsequently removed from the transport path.

Following the cleaning step, a second substrate, also composed of a porous material, may be provided. This second substrate may be treated with a treatment solution designed to form a protective coating on the cutting blade(s) and/or cutting block. Optionally, this second substrate may be the same item as the first substrate but positioned in a different orientation so that the cutting blade(s) will contact and cut into a different location on the substrate than they did on the first pass of the substrate. The second substrate may be inserted into the transport path, and the printer may be activated once more to cause the cutting blade(s) to extend and contact the second substrate. The treatment solution may contact the cutting components, forming a protective layer that helps prevent future adhesive buildup. This layer may act as a barrier, ensuring that the cutting blade and cutting block remain functional for longer periods between maintenance cycles. Upon retraction of the blade(s) from the second substrate, at least a portion of the treatment solution may remain in contact with the cutting blade and cutting block, providing ongoing protection.

The two-step process may ensure comprehensive maintenance of the printer's cutting components. The initial cleaning step may remove existing residues on the cutting elements, while the subsequent treatment step may apply a protective coating to reduce the rate of future buildup of residue on the cutting elements. This method may be particularly beneficial for environments with high usage of adhesive labels, where frequent maintenance is required to keep the printers operational.

In some embodiments, the cleaning solution and the treatment solution may be the same, simplifying the maintenance process. This combined solution may simultaneously clean and provide a protective coating, reducing the need for separate substrates and steps. By streamlining the procedure, the efficiency of maintaining the printer may be further enhanced, making it easier and quicker for users to perform routine maintenance.

The effectiveness of this two-step or combined solution process may be influenced by the properties of the substrates used. The substrates may need to be porous enough to absorb and retain the solutions, yet durable enough to withstand the mechanical action of the cutting blade and block. Suitable materials for these substrates may include various types of foam, cellulose tissue, and non-cellulosic materials, each selected based on their absorption properties and compatibility with the cleaning and treatment solutions used.

The density and thickness of the substrates may also be crucial factors. The substrates may need to be thick enough to ensure thorough contact with the cutting components, facilitating effective cleaning and treatment. A thickness at least equal to or greater than the cutting blade may ensure sufficient interaction, while the density may balance between being firm enough to offer resistance to the blade and flexible enough to conform to the blade's shape for optimal application of the solutions.

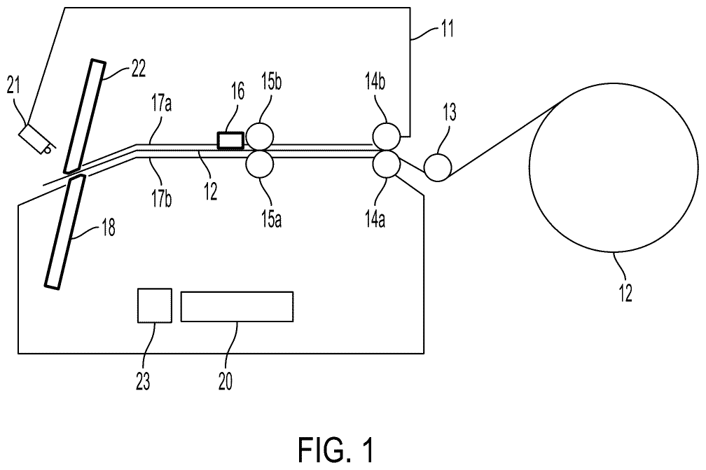

FIG. 1 is a schematic diagram illustrating an example configuration of a printer such as a label printer. The printer 11 may receive labels, papers or other substrates that provide a print material onto which the printer's print head will apply ink or toner from the roll tag or paper 12 through a tension roller 13. The received print material may be transported in the transport direction along a transport path 17 (shown in the figures by boundaries 17a and 17b) through the transport roller pairs 14a, 14b, 15a, and 15b. A print head 16 will apply ink or toner to the print material to print characters and/or images on the print material. The print material may then be cut by one or more cutting blades 18, 22. Alternatively, element 22 of the cutting mechanism may be a cutting block that receives the blade(s). The present disclosure is not limited to any particular printer configuration, such as a single cutting blade or a pair of opposing cutting blades 18, 22. In other words, some embodiments of the present disclosure may include a single cutting blade (optionally, along with a cutting block) or more than two cutting blades, depending on the type of application. For purposes of simplicity, the remainder of this disclosure will simply refer to the one or more cutting blades as cutting blade 18, and it will refer to the optional cutting block as cutting block 22.

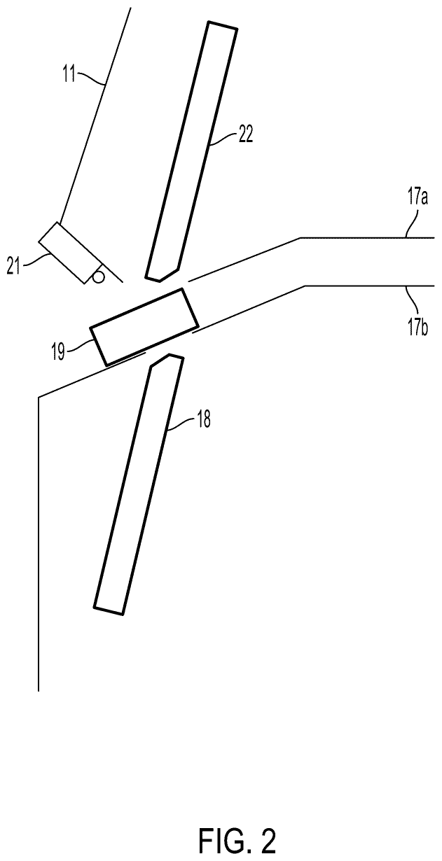

Once treated, the cleaning substrate 19 may be inserted into the transport path 17 of the printer 11, as shown in FIG. 2. For the treatment, the cutting blade(s) 18 and cutting block 22 may be moved to their retracted positions to allow the substrate 19 to be positioned into the transport path 17 without obstruction. The insertion process of the substrate 19 may be performed manually by a user, who carefully places the substrate into the transport path 17, ensuring that the substrate is properly aligned for optimal cleaning. Alternatively, the insertion may be carried out automatically by a machine or a robotic device, which uses a processor 20 and computer-executable programming instructions stored in a memory device 23 to receive data from a sensor 21 indicating positioning of a label in the device. Examples of a sensor 21 include a camera, a pressure sensor that detects when the edge of the label or other substrate abuts against the sensor, or other sensors. The processor 20 can be located inside the label printer 11 as shown in FIG. 1 or placed externally. This processor is responsible for interpreting the sensor data to cause precise movements of the device components to accurately position the substrate 19 within the transport path 17. This automation may enhance efficiency and reduce the potential for human error, providing a consistent and reliable setup for the subsequent cleaning process.

In some embodiments, the blades 18 and opposing blades or cutting block 22 may be positioned further apart when in the retracted positions than when in the cutting positions. When a single blade 18 is used, element 22 may serve as a cutting block, and the blade 18 may be positioned further from the cutting block 22 in the retracted position than in the cutting position. When a cutting block 22 is provided, it may be stationary, or it may extend and retract, depending on the printer's design. Either way the cutting block 22 will serve as a base against which the blade 18 may press when cutting a label or other substrate 19.

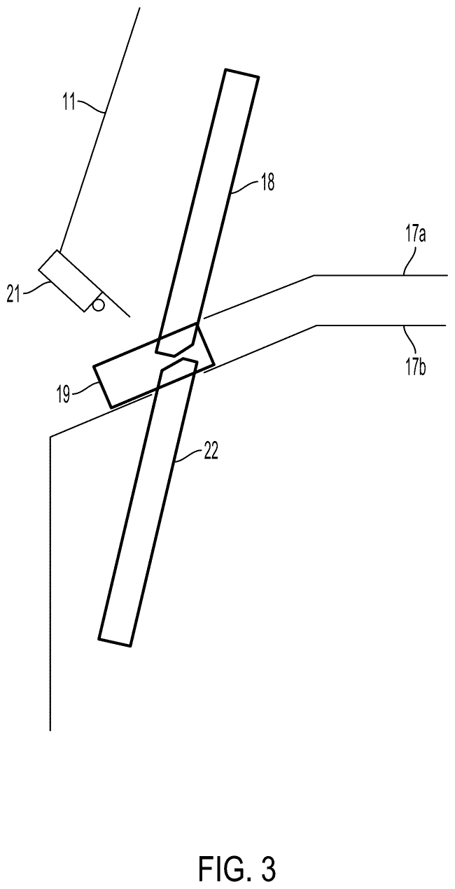

As shown in FIG. 3, the printer 11 may then be activated to cause the cutting blade 18, or the cutting blade 18 and the cutting block 22, to extend from their retracted positions into a cutting position where they may contact the substrate 19. This contact may facilitate the transfer of the cleaning and/or treatment solution to the cutting blade 18, or the cutting blade 18 and the cutting block 22. The cleaning and/or treatment solution may effectively remove any adhesive residue or debris from these components, ensuring the blade remains sharp and the cutting mechanism remains functional. By maintaining the cleanliness of the cutting mechanism, the overall performance and precision of the label printer 11 may be significantly enhanced, leading to improved print quality and reduced maintenance requirements.

However, if there is excessive buildup that may not be fully cleaned by the cutting steps alone, additional methods may be employed before conducting the cleaning steps. For example, a preliminary manual cleaning with a scraper or brush may be used to remove large accumulations of adhesive. Alternatively, a pre-cleaning cycle involving a solvent spray or soaking solution may be implemented to break down and loosen stubborn residues. These supplementary methods may ensure that the subsequent cleaning steps with the substrate and cleaning and/or treatment solution are more effective, ultimately maintaining the optimal functionality of the printer.

In embodiments where a single cutting blade 18 and a cutting block 22 are used, the single blade may move downward to get closer to the single block, ensuring precise contact with the substrate. Alternatively, both the single blade and the single block may be moved towards each other, converging to achieve the same effective cleaning action. This flexibility in movement ensures that the cleaning and/or treatment solution is thoroughly and evenly applied to the cutting surfaces, effectively removing adhesive residue and debris. Such adaptability guarantees that the cleaning process is efficient and effective, regardless of the specific configuration of the cutting mechanism. This improves maintenance of the cutting components, thereby enhancing the overall functionality and longevity of the label printer.

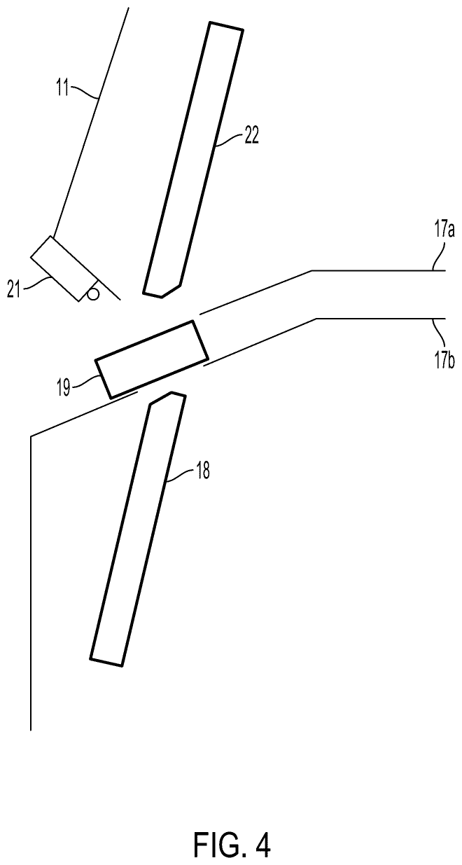

As shown in FIG. 4, the blade 18, or the cutting blade 18 and the cutting block 22, may then retract away from the substrate 19. Upon retraction, at least a portion of the cleaning and/or treatment solution may remain in contact with these components. This residual cleaning and/or treatment solution may provide ongoing protection against adhesive buildup, ensuring that the cutting blade 18, or the cutting blade 18 and the cutting block 22, maintain high quality functionality and reduce the need for frequent manual cleaning. This continuous protection may enhance the overall efficiency and longevity of the label printer 11, reducing downtime and maintenance costs.

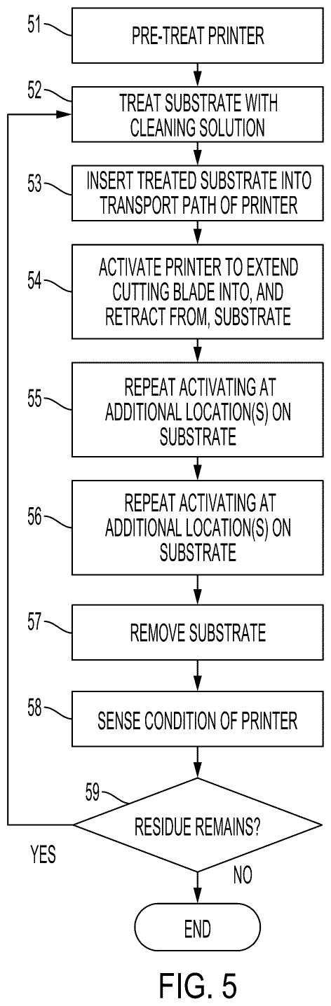

As shown in FIG. 5, a diagram illustrating various steps of a label printer cleaning process is provided. The method for cleaning a label printer begins with pre-treating the printer (Step 51), ensuring it is in a ready state for cleaning. Next, the substrate, which includes a porous material, is treated with a cleaning and/or treatment solution (Step 52). This treatment can involve various methods such as spraying, soaking, or applying the cleaning and/or treatment solution through a coating method. After the substrate is adequately treated, it is inserted into the transport path of the label printer, positioning it to come into contact with the cutting blade and cutting block during printer operation (Step 53).

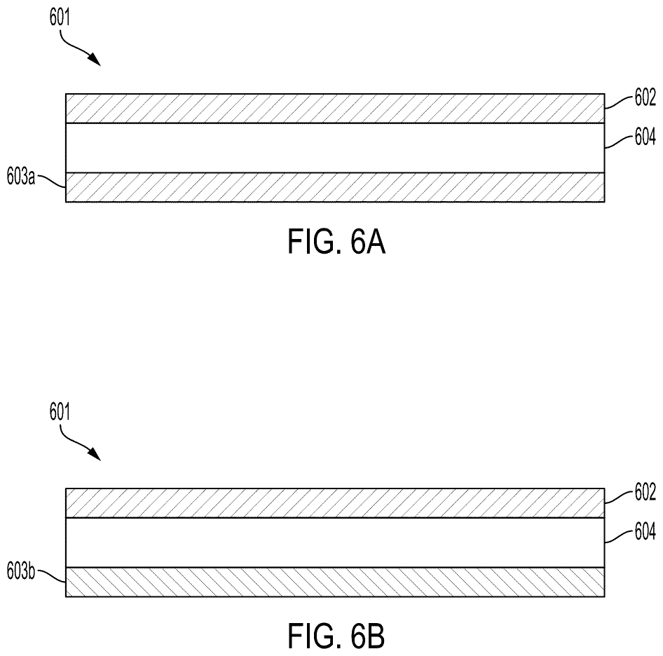

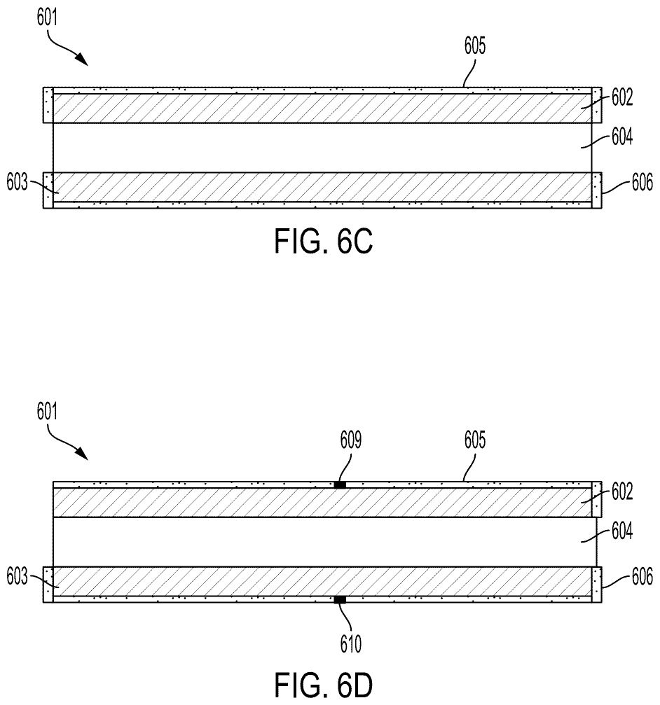

The printer is then activated, causing the cutting blade to extend into a first side of the substrate and retract from the cleaning substrate (Step 54). Optionally, the cutting block also may extend toward and contact a second side of the substrate. This process ensures that the cleaning and/or treatment solution contacts these components, leaving a portion of the solution on the cutting blade and cutting block after retraction. In some embodiments, if the cleaning substrate includes a shield layer of non-porous material over the cleaning layer that contains the treatment solution, when the cutting blade extends into the substrate at Step 54, the blade will pass through the shield layer to expose the blade to the cleaning solution. This option will be described in more detail in the discussion of FIGS. 6A-6C below.

To help provide an even more thorough cleaning and/or treatment, the activation that causes the cutting blade and (optionally) cutting block to extend and retract cause may be repeated at additional locations on the substrate as it moves along the transport path (Step 55). This can include rotating the substrate to expose various parts to the cutting blade and securing the substrate in place within the transport path for stability.

The activation process is repeated at further additional locations on the substrate as needed to achieve comprehensive cleaning (Step 56). Once the cleaning process is deemed complete, the substrate is removed from the transport path (Step 57). The condition of the printer is then sensed and evaluated to determine the effectiveness of the cleaning and whether any adhesive residues remain on the cutting blade or cutting block (Step 58).

If any residue is detected, the cleaning process is repeated until the printer is confirmed to be free of residue (Step 59). Once no significant amount of residue remains, the cleaning procedure concludes, ensuring the label printer is properly maintained and ready for use.

However, a concern is that an excessive amount of cleaning and/or treatment solution may remain on the cutting blades or blocks, potentially interfering with the optimal operation of the printer. To address this, additional methods may be employed. For example, an absorbent wiper or squeegee mechanism may be incorporated to remove excess solution from the cutting components after the cleaning cycle. Additionally, an air-blowing system or heated drying mechanism may be used to ensure that only the necessary amount of cleaning and/or treatment solution remains, while excess liquid is evaporated or blown away. Furthermore, the system may be configured to allow time for the cleaning and/or treatment solution to evaporate or dry up from the blades and blocks before resuming printing. These supplementary methods may ensure that the cutting blades and blocks are left clean and dry, maintaining the best possible operational conditions for the printer.

After completing the cleaning steps, the cutting blades and the block still may have some residual buildup or excessive liquids. This condition may be detected by a sensor that monitors the cleanliness and dryness of these components. For instance, optical sensors can be used to visually detect residue accumulation on the cutting blades or cutting block. These sensors can identify adhesive buildup by detecting changes in reflectivity or opacity on the surfaces of the blades and block.

Additionally, capacitive or inductive sensors can be employed to measure changes in electrical properties that indicate the presence of residues or moisture. Capacitive sensors detect changes in capacitance caused by the presence of adhesive or liquid residues on the cutting components, while inductive sensors detect changes in inductance when conductive materials, such as residues, are present.

Temperature sensors, such as infrared thermometers, can also be used to monitor the dryness of the components. These sensors can detect temperature changes that indicate whether the cleaning and/or treatment solution has evaporated or if excess liquid remains.

Incorporating these sensors ensures that any remaining residues or excess liquids are promptly detected, triggering an additional cleaning cycle or notifying the user for further manual intervention.

This proactive approach ensures that the cutting components are thoroughly cleaned and maintained, preventing any interference with the printer's operation and thereby enhancing the overall reliability and performance of the label printer.

The method may include additional steps to enhance the cleaning process. For instance, the printer may be activated multiple times to cause the cutting blades, or the cutting blade and the cutting block, to extend and retract at various locations on the substrate, ensuring comprehensive cleaning. The substrate may be positioned to contact not only the cutting blades or the cutting blade and the cutting block but also other parts of the printer that come into contact with adhesive residues. By doing so, the method may ensure a thorough cleaning of all relevant components, thereby improving the overall efficiency and longevity of the printer. This repeated activation and strategic positioning of the substrate may effectively eliminate adhesive buildup and maintain the printer in optimal working condition.

To further improve the cleaning efficiency, the substrate 601 may be designed with a multi-layer structure, as illustrated in FIGS. 6A-6D. A first cleaning material layer 602 may be an absorbent layer formed of a porous material to retain the cleaning and/or treatment solution. The first cleaning material layer 602 may be made from materials such as cellulose or sponge-like polymers, to help ensure that the cleaning and/or treatment solution is retained and gradually released during the cleaning process.

A second cleaning material layer 603 may be formed of the same porous material as illustrated by second cleaning material layer 603a of FIG. 6A. Alternatively, the second cleaning material layer 603b may be formed of a different type of material as shown in FIG. 6B. If formed of a different material, the second cleaning material layer 603b may include a different porous material than that of the first cleaning material layer 602. Alternatively, the second cleaning material layer 603b may be formed of an abrasive material to help remove stubborn residues. The abrasive material may be composed of slightly rough materials like microfiber or fine-grit materials, may assist in scrubbing away dried or stubborn adhesive residues from the cutting blade and cutting block. An optional support layer 604 may serve as a supporting core to hold the materials together, formed of plastic, cellulosic material, or some other material that is semi-rigid to provide a supporting core. The first cleaning material layer 602 and the second cleaning material layer 603 (when present) may be affixed to the opposite sides of the core by any suitable attachment process. This multi-layer design may enhance the effectiveness of the cleaning process, ensuring that all residues are thoroughly removed and the cutting components remain in optimal condition.

The substrate may be in forms, patterns, arrangements, or structures known in the art or field, including, but not limited to, ones described in U.S. Pat. Nos. 5,525,417, 5,227,226, 7,540,055, 7,631,390, 7,732,040, 7,846,534, 10,307,796, 11,410,003, 11,710,011, 11,816,513, 11,110,492, and U.S. Patent Application Pub. No. 2023/0256476, all of which are hereby incorporated herein by reference. Other cleaning substrates, such as wipes and towelettes, may be used in other embodiments.

In some embodiments, as shown in FIG. 6C, a first shield layer 605 may be positioned over and envelop at least the first cleaning material layer 602. This can help retain the treatment solution in the first cleaning material layer 602 until the substrate is used to clean a printer. The presence of a shield layer 605 can also help inhibit the treatment solution from contacting the transport path's rollers 15a, 15b (see FIG. 1), which could otherwise cause the rollers to become slippery and impair the rollers' ability to use friction contact to move labels or other print substrates through the printer's path. The first shield layer 605 may envelop the first cleaning material layer 602 as shown in FIG. 6C, or it may envelop the entire substrate 601. Optionally, a separate, second shield layer 606 may envelop the second cleaning material layer 603 as shown in FIG. 6C.

The shield layer(s) 605, 606 may be formed of any non-porous material through which the treatment solution will not flow in any significant amounts during typical use before the material has degraded, and which is thin enough to be able to be easily cut by the cutting blade of the printer. Example non-porous materials include, without limitation, plastics such as high-density polyethylene (HDPE), low-density polyethylene (LDPE), linear low-density polyethylene (LLDPE), or other polyethylenes. Other examples include biodegradable plastics and biopolymers such as polybutylene succinate (PBS), polycaprolactone (PCT), polylactic acid (PLA), and poly(butylene adipate terephthalate) (PBAT). In this disclosure, the term “non-porous” does not necessarily mean that no amount of treatment solution will escape through the layer, no matter the time or conditions. Many plastic materials exhibit a limited degree of porosity at a microscopic level, and some plastics—such as biodegradable plastics—can become porous over a longer period of time.

When one or more shield layers 605 (and optionally 606) are included to retain the treatment solution in the one or more cleaning material layers 602 (and optionally 603), then during use when printer's cutting blade is activated to extend into the substrate, it may pass through at least one of the shield layers to reach the cleaning material layer by puncturing the shield layer. This will create a small opening in the shield layer 605 so that the treatment solution will transfer to the cutting blade when extended. Optionally, if the shield layer envelops both sides of the substrate, the cutting blade may puncture the shield layer on both sides, thus creating a second hole through which treatment solution may pass to the cutting block. When the cutting blade is retracted out of the cleaning layer, the opening(s) will remain in the shield layer(s) but will remain small enough that a significant amount of treatment solution will not transfer to the printer's transport rollers as the substrate moves through the transport path.

In some embodiments such as that shown in FIG. 6D, the shield layer(s) 605, 606 may include one or more pre-punctured sections 609, 610 that are positioned at the location(s) where the substrate will receive the extended cutting blade(s). The pre-punctured section(s) 609, 610 may be formed as perforations, slits, or other openings that are structured to make it easier for the cutting blade to extend through the shield layer(s) 605, 606, while remaining small enough to avoid a significant amount of treatment material to pass through during use.

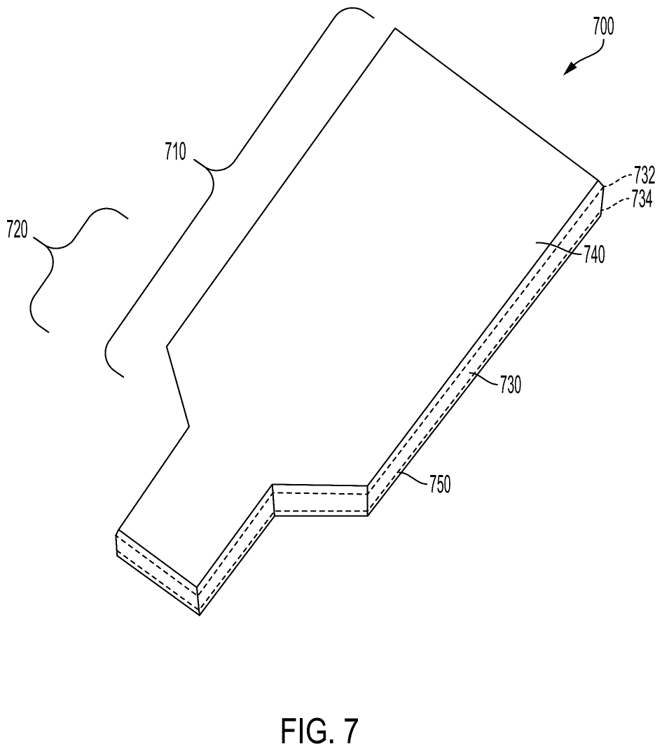

FIG. 7 illustrates another possible substrate structure. FIG. 7 illustrates an isometric view of an example of a cleaning tool 700 that includes a body portion 710 and optionally a neck portion 720. For example, the body portion 710 may have a width of about 2 inches to about 2.5 inches, and the neck portion 720 may have a width of about 0.8 inches to about 1.2 inches. In another example, the body portion 710 may have a width of about 2.125 inches+/−0.12 inches, and the neck portion 720 may have a width of about 1.0 inches+/−0.12 inches. Other sizes are possible. The wide body portion 710 may allow for wide-area cleaning of media transport device components, while the narrow neck portion 720 may allow for fine-area cleaning of hard-to-reach media transport device components, as will be described in more detail below. However, this configuration is optional, and the cleaning pad may have other shapes or sizes such as rectangular, square, oval, triangular, teardrop-shaped, or other shapes.

The cleaning tool 700 may have multiple layers. For example, the cleaning tool 700 may have a cleaning material layer 740 and an abrasive material layer 750. The abrasive material layer 750 may be made from a rigid or semi-rigid material, such as polyvinyl chloride (PVC) or other plastic that is formed to have an abrasive, irregular shape such as in interlocking loops.

The overall thickness of the cleaning tool 700 is thin enough to fit into a media transport device. For example, the overall thickness of the cleaning tool 700 may be no more than 0.1 inch, no more than 0.08 inches, or another size (such as for example about 0.6 inches, or 0.5 inches+/−0.03 inches). Despite this thin shape, the cleaning tool will be rigid enough to provide force against components to be cleaned. To accomplish this, the cleaning tool may exhibit a Young's modulus of about 225 Gigapascal (GPa) to about 460 GPa. In other embodiments, the cleaning tool may exhibit a Young's modulus of about 100 GPa or about 200 GPa or about 225 GPA at the low end, up to any higher number such as about 460 GPA or about 600 GPa or about 1000 GPA. This feature may be enabled with an abrasive material layer 750 may that has a Young's modulus stiffness value greater than a Young's modulus stiffness value of the cleaning material layer 740. To do this, the abrasive material layer 750 may be made of the rigid or semi-rigid material as described above and also have a thickness that is greater than that of the cleaning material layer 740. In some embodiments, the thickness of the abrasive material layer 750 may be at least 2× that of the cleaning material layer 740, at least 3× that of the cleaning material layer 740, at least and/or up to 4× that of the cleaning material layer 740, at least and/or up to 5× that of the cleaning material layer 740, or up to approximately 6× that of the cleaning material layer 740. Other relative thicknesses are possible.

The cleaning material layer 740 may be made from a soft material, such as a microfiber, nylon, or other non-woven spunbound material, or a foam such as those materials described in previous sections of this disclosure. The cleaning material layer 740 may hold a treatment solution as described above in ither embodiments.

Optionally, the cleaning tool 700 also may include a core layer 730 comprising a first surface 732 and a second surface 734 opposite the first surface 732. If the cleaning tool 700 includes a core layer, the cleaning material layer 740 may cover some or all of the first surface 732 of the core layer 730, and the abrasive material layer 750 may cover some or all of the second surface 734 of the core layer 730. The cleaning material layer 740 and/or abrasive material layer 750 may be connected to core layer 730. For example, the cleaning material layer 740 and/or abrasive material layer 750 may be joined to core layer 730 with an adhesive. Alternatively, the layers may be joined together by solvent bonding, vibration welding, induction welding, simple mechanical fastening, or the like.

In some embodiments, the core 730 may be omitted. When this configuration is used, the cleaning material layer 740 and abrasive material layer 750 may be directly connected to each other via an adhesive or connective structure without a core layer.

If a core layer is used, the core layer 730 may have a Young's modulus stiffness value greater than a Young's modulus stiffness value of the abrasive material layer 750 and a Young's modulus stiffness value of the cleaning material layer 740. Alternatively, layers 730, 740, and/or 750 may have the same or similar Young's modulus stiffness values.

The core layer 730, cleaning material layer 740, and/or abrasive material layer 750 may be made from a plastic material. For example, the plastic material may be a rigid or semi-rigid material, such as high-density polyethylene (HDPE), polypropylene (PP), polyethylene (PE), polyvinyl chloride (PVC), polyethylene terephthalate (PET), polystyrene (PS), polylactic acid (PLA), polycarbonate (PC), acrylic (PMMA), acetal (polyoxymethylene, POM), nylon (PA), high-impact styrene, acrylonitrile butadiene styrene (ABS), or the like. Alternatively, the core layer 730, cleaning material layer 740, and/or abrasive material layer 750 may be made from other materials, such as metal, latex rubber, organic material, or the like.

When a core layer is used, the core layer 730 may have a thickness sufficient to provide a stiff implement upon which to clean media transport device components. The stiffness of the core layer 730 may allow for pressing the cleaning tool against media transport device components having sharp edges without the destruction of the cleaning tool. For example, the core layer 730 may clean the sharp edge of a printer label cutter, as will be described in more detail below.

The cleaning material layer 740 may have a thickness sufficient to provide a soft nap upon which to clean media transport device components. For example, the cleaning material layer 740 may have a thickness of about 0.005 inches to about 0.02 inches or about 0.04 inches. In some embodiments, the thickness of the fiber layer may be about 0.11 inches. The cleaning material layer 740 may include a pretreatment coating. The cleaning material layer 740 may include a soft nap material (such as a microfiber material) having an absorbent property capable of receiving one or more cleaning solvents. For example, the soft nap material of the cleaning material layer 740 may be coated with a cleaning solvent, such as ethyl alcohol, ethanol, a solution with either of those components, or another solution. For example, an alcohol based cleaning solvent may include: (i) approximately 20% to approximately 25% or 30% ethanol; (ii) zero to approximately 3% or 5% ethyl acetate; (iv) zero to approximately 3% polyalkyleneoxide modified heptamethyl trisiloxane, and a remainder (such as approximately 75%) that is water, such as deionized water. The pretreatment coating of the cleaning material layer 740 may be applied onto the media transport device components to loosen the printing supply waste, dirt, debris, or the like from media transport device components.

The abrasive material layer 750 may have a thickness sufficient to provide an abrasive implement upon which to clean printer components. For example, the abrasive material layer 750 may have a thickness of about 0.05 inches to about 0.08 inches. In some embodiments, as shown in FIG. 1, the thickness of the fiber layer may be about 0.065 inches. The abrasive material layer 750 may include a plurality of rigid hooked curls. For example, the rigid hooked curls of the abrasive material layer 750 may break apart and capture printing supply waste, dirt, debris, or the like from media transport device components. In other embodiments the abrasive properties of the scouring layer may be derived from ridges formed in the layer, scoring of the layer, or patterns such as those described in any of the following U.S. Pat. Nos. 8,323,779; 7,846,534; 7,631,390; or 7,540,055. The disclosures of each of these patents are fully incorporated into this document by reference.

The cleaning tool 700 having cleaning material layer 740, abrasive material layer 750 and optional core layer 730 shown in FIG. 7 may have a combined overall thickness of no more than 0.1 inches, or no more than 0.2 inches, or no more than 2.25 inches. For example, the overall thickness of the tool may be about 0.075 inches+/−0.03 inches. The slim profile of the cleaning tool 700 allows for insertion of the tool into tight areas of a media transport device, while a cleaning tool 700 having a larger profile may allow for cleaning of large areas of a media transport device. Alternatively, a tool kit having multiple cleaning tools 700 of various sizes and thicknesses may be provided to allow a user to clean media transport devices of various sizes, having various internal opening dimensions, and/or having various sized surface areas to clean.

Optionally, the cleaning tool 700 may have a relatively small surface area. For example, the tool may have a length of 4.5 inches+/1 0.12 inches and a maximum width of 2.125 inches+/1 0.12 inches. Other sizes are possible. For example, the cleaning tool 700 may have an overall surface area of about 4.5 square inches (in²) to about 8.5 in².

The cleaning material layer 740 and abrasive material layer 750 may have different colors to indicate to the user which side to use first. For example, the cleaning material layer 740 may have a lighter color than the abrasive material layer 750 and the cleaning instructions provided with the cleaning tool may instruction the user to pretreat the printer component first with the lighter side of the cleaning tool followed by scrubbing the printer component with the darker side, as will be described in more detail below. Alternatively, the cleaning material layer 740 and abrasive material layer 750 may have the same color. Indicia may be included within the cleaning material layer 740 and/or abrasive material layer 750 to provide cleaning instructions.

A cleaning tool such as that described above may be used to clean one or more components of printer, such as a label printer, by: (a) exposing the component and/or inserting the cleaning tool into the printer adjacent the printer component; (b) wiping the fiber layer of the cleaning tool against the printer component; (c) removing the cleaning tool from the printer; (d) rotating the cleaning tool; (e) reinserting the cleaning tool into the printer adjacent the printer component; (f) wiping the scouring layer of the cleaning tool against the surface of the printer component; and (g) removing the cleaning tool from the printer after the printer component is sufficiently cleaned.

Wiping the fiber layer of the cleaning tool against the printer component may pretreat the printer component with one or more cleaning solvents. Wiping the scouring layer of the cleaning tool against the printer component may break apart and capture printing supply waste, dirt, debris, or the like from the printer component.

In some embodiments, the cleaning material layer 740 or the entire cleaning tool 700 may be contained within a non-porous material to retain treatment solution in the cleaning material layer 740 until the cleaning tool is used and the printer knife punctures the non-porous material.

In some embodiments, the substrate may be pre-saturated with the cleaning and/or treatment solution and provided in a sealed pouch to prevent evaporation. This arrangement may make the cleaning process more convenient, as the substrate is ready to use immediately upon removal from the pouch. Alternatively, the cleaning and/or treatment solution and substrate may be packaged separately, allowing the solution to be applied to the substrate just before use.

As another example, illustrates a package containing a first sealed pouch and a second sealed pouch may be employed. One of the pouches will contain the cleaning tool with cleaning solution such as that described above absorbed into or otherwise held by the fiber layer. The other pouch may contain a blotter pad that may be used to further clean and dry the components after the cleaning tool has been used. The second pouch and blotter pad are optional, and in some embodiments a single pouch with a cleaning tool may be provided.

When the tool is packaged, the package should be impermeable so that cleaning solution will not seep out of the pouch that contains the cleaning solution. Example pouch materials may include plastic, a coated paper such as poly paper, or other waterproof materials. When multiple pouches are used, the package may include a spacer that is positioned between the pouches to prevent cleaning solvent from transferring from the pouch that contains the solvent. The spacer may be a physical structure or simply an adhesive that is resistant to dissolving when contacted by the solvent. Example adhesives include ionomer resins such as that sold under the brand name SURLYN®.

This flexibility in packaging may accommodate different user preferences and ensure that the cleaning and/or treatment solution is fresh and effective at the time of application. A cleaning tool such as that described above may be, or may be an element of, a cleaning system.

The substrate may be configured to disintegrate upon use, leaving no residue in the transport path. This feature can be achieved through the use of materials that break down easily under mechanical stress and exposure to cleaning and/or treatment solutions. For example, the substrate can be composed of biodegradable polymers or water-soluble materials, such as polyvinyl alcohol (PVA) or certain cellulose-based compounds. These materials disintegrate into fine particles when subjected to the friction and pressure of the cutting process, ensuring that no substantial residue is left behind.

The substrate may also be designed with a multi-layer structure that facilitates disintegration. For instance, an inner layer made of water-soluble material can be sandwiched between outer layers of biodegradable polymer. Upon contact with the cleaning and/or treatment solution and the mechanical action of the cutting blades, the inner layer dissolves, causing the outer layers to break apart and disintegrate.

Additionally, the substrate may be designed to be secured in place within the transport path to ensure stability during the cutting process. This secure positioning can be achieved using a variety of methods. One approach is to incorporate adhesive strips or patches on the substrate that temporarily adhere to the transport path, keeping the substrate in place during the cleaning process. Alternatively, the substrate can be designed with a textured or interlocking surface that engages with corresponding features in the transport path, providing a stable and secure fit.

Another method to secure the substrate involves the use of a frame or carrier that holds the substrate in place. This frame can be made of a rigid or semi-rigid material that fits snugly into the transport path, ensuring that the substrate remains stationary during the cleaning process. The frame can be designed to be easily removable, allowing for quick and convenient replacement of the substrate after each cleaning cycle.

By incorporating these structural and compositional features, the substrate effectively disintegrates upon use and remains securely positioned within the transport path, ensuring thorough and effective cleaning without introducing new contaminants into the printer.

The substrate may also be heated before insertion to enhance the effectiveness of the cleaning and/or treatment solution. Heating the substrate above an ambient temperature of the environment in which the printer exists may help activate the cleaning and/or treatment solution, improving its ability to break down adhesive residues. The substrate may be made from a heat-resistant material to ensure it remains intact during the cleaning process. When the printer's cutting blade and cutting block are activated to contact the heated substrate, the cleaning action may be enhanced by making the adhesive residues more pliable and easier to remove. This method may significantly improve the efficiency and thoroughness of the cleaning process, ensuring optimal performance of the label printer.

A rotating mechanism may be integrated within the printer to rotate the substrate as it moves along the transport path. This feature ensures that different sections of the substrate come into contact with the cutting blade and cutting block, thereby providing a more comprehensive and thorough cleaning.

An example of such a rotating mechanism may include a motorized spindle or roller system. The substrate can be attached to a spool that is mounted on the spindle. The motor drives the spindle, causing the spool to rotate at a controlled speed. This rotation ensures that various parts of the substrate are exposed to the cutting blade and cutting block, effectively increasing the cleaning area. The rotation can be synchronized with the printer's cutting cycle to optimize the cleaning action.

To securely fasten the substrate in place and prevent unintended movement during the cutting process, several methods can be employed. One approach is to use a clamping system. The substrate can be held in place by clamps that are integrated into the transport path. These clamps can be manually or automatically engaged to secure the substrate. For instance, spring-loaded clamps can provide a firm grip on the substrate, ensuring it remains stationary during the cleaning process.

Alternatively, an adhesive backing can be applied to the substrate. This adhesive can be designed to provide temporary adhesion to the transport path, ensuring the substrate does not shift during the cutting process. The adhesive should be strong enough to hold the substrate in place but also allow for easy removal and replacement after the cleaning cycle.

Another example mechanism involves using a frame or cartridge that houses the substrate. This frame can be designed to fit snugly within the transport path, providing structural support and preventing movement. The frame can have interlocking features or grooves that align with corresponding parts of the transport path, ensuring precise positioning. Additionally, the frame can be equipped with a locking mechanism to hold the substrate firmly in place.

By incorporating these structural features, the rotating mechanism and secure placement system ensure that the cleaning and/or treatment solution is applied consistently and evenly across the blade and block, maximizing the efficiency of the cleaning action. The combination of rotation and secure placement may significantly enhance the overall effectiveness of the cleaning method, ensuring that the label printer maintains optimal performance and longevity.

The present disclosure offers a comprehensive and practical solution to the persistent problem of adhesive buildup on label printer cutting blades and cutting blocks. By employing a substrate treated with a specialized cleaning and/or treatment solution, this method may significantly simplify maintenance procedures, minimize printer downtime, and ensure consistent high-quality printing. This innovative approach may be especially beneficial in environments where label printers are heavily utilized, such as retail stores, warehouses, and food service establishments. The method's ability to maintain the cleanliness and efficiency of the cutting components may directly contribute to sustaining optimal printer performance and reliability. This, in turn, may support the high operational demands and rigorous usage patterns typical of these industries, ultimately enhancing productivity and reducing the need for frequent manual interventions.

The method may be designed to be exceptionally user-friendly, requiring minimal technical expertise to execute. It may allow for quick and efficient cleaning without necessitating the disassembly of the printer, thereby reducing the time and effort needed for routine maintenance. This user-centric approach may significantly minimize printer downtime, ensuring that the device remains operational and productive for longer periods. When the cleaning and/or treatment solution is applied through the described methods, it may effectively prevent adhesive buildup on the cutting blades and cutting blocks, thereby prolonging the operational life of these critical printer components. This not only may enhance the overall performance and reliability of the printer but also may contribute to lowering maintenance costs and extending equipment lifespan.

The frequency of conducting the cleaning steps may be based on a predetermined period, ensuring regular maintenance and preventing significant adhesive buildup on the cutting blades and cutting block. Alternatively, a sensor may be utilized to determine the degree of adhesive buildup, triggering the cleaning process when necessary. This sensor may be a visual sensor that detects residue accumulation on the cutting blades or cutting block, or it may be sensors that monitor and evaluate the printing performance, concluding that there is excessive buildup that needs to be cleaned out. These sensors may provide real-time feedback, ensuring that the printer initiates the cleaning cycle precisely when required, thereby maintaining optimal performance and print quality. This automated approach may provide a more efficient and timely response to maintenance needs, reducing the likelihood of printer downtime. Additionally, users may manually initiate the cleaning steps whenever they notice a decline in print quality or increased adhesive residue. Implementing these various methods for determining the frequency of cleaning not only enhances the practicality of the method but also allows for flexibility depending on the specific operational environment and maintenance requirements. This versatility has not been explicitly described in previous sections, making it a valuable addition to the overall cleaning method.

When the cleaning and/or treatment solution contacts the blade and block, it may form a protective coating that prolongs the time before adhesive buildup occurs again. This protective coating can be achieved through the remainder of the cleaning and/or treatment solution, a lubricant, and/or an anti-adhesive agent that collectively act as a release layer. This layer prevents adhesive residues from sticking to the cutting surfaces as quickly, thereby extending the maintenance intervals. By incorporating this feature, the cleaning method not only removes existing residues but also provides ongoing protection to enhance the overall efficiency of the label printer. This dual-action approach ensures that the printer remains in optimal condition for a longer period, reducing downtime and the frequency of manual cleaning.

The protective coating can include lubricants or anti-adhesive agents such as Teflon or other non-stick materials known for their durability and resistance to adhesive buildup. The application of this coating can be integrated seamlessly into the cleaning cycle, ensuring that every time the cleaning and/or treatment solution is applied, a fresh layer of the protective coating is also deposited. This not only cleans the cutting blade and cutting block but also leaves behind a micro-thin barrier that significantly reduces the adhesion of subsequent labels' adhesive residues.

Over time, this can lead to a marked reduction in maintenance efforts and an increase in the overall lifespan of the cutting components. The method can be especially beneficial in high-volume printing environments where frequent label changes can lead to rapid adhesive buildup, thus ensuring continuous operation with minimal interruptions. Furthermore, this protective feature aligns with the broader goal of the disclosed method to provide a comprehensive, user-friendly, and efficient maintenance solution that enhances the reliability and performance of printers across various industries.

In summary, the method for cleaning a label printer may involve providing a substrate treated with a specialized cleaning and/or treatment solution, inserting the substrate into the transport path of the printer, and activating the printer to cause the cutting blade and cutting block to contact the substrate. This contact may allow the cleaning and/or treatment solution to effectively reduce adhesive buildup, thereby prolonging the operational efficiency and lifespan of the printer. Various embodiments of this method, such as pre-saturating the substrate, incorporating multi-layer structures, and utilizing rotating mechanisms, may further enhance its effectiveness. These enhancements may make the method a versatile and reliable solution for maintaining label printers in optimal condition, ensuring consistent print quality and reducing maintenance-related downtime in diverse operational environments.

The following paragraphs provide additional information about various terms used in this document:

The terms “memory,” “memory device,” “computer-readable medium” and “data store” each refer to a non-transitory device on which computer-readable data, programming instructions or both are stored. A “computer program product” combination of a memory device and the programming instructions stored in it. Unless the context specifically states that a single device is required or that multiple devices are required, the terms defined in this paragraph include both the singular and plural embodiments, as well as portions of such devices such as memory sectors.

The terms “printer” and “print device” refer to a machine having hardware capable of reading digital data and using the information from the data and associated print instructions to print a physical document on a substrate. Components of a print device typically include a print engine, as well as a document transport system configured to pass a substrate through a transport path of the print device so that one or more print heads of the print engine can apply ink or toner to form characters and/or images on the substrate.

The terms “processor” and “controller” refer to electronic device hardware that is configured to execute programming instructions. The terms “processor” and “controller” may refer to either a single processor or controller, or to multiple processors or controllers that together implement various steps of a process. Unless the context specifically states that a single processor or controller is required or that multiple processors or controllers are required, the terms “processor” and “controller” include both the singular and plural embodiments.

The following clauses further describe various embodiments of the inventive concepts:

Clause 1: A method of cleaning cutting elements of a printer comprises: (a) providing a substrate comprising a porous material treated with a treatment solution, wherein the treatment solution comprises a cleaning and/or coating solution; (b) inserting the substrate into a transport path of a printer; and (c) activating the printer. Activating the printer causes a cutting blade of the printer to extend from a retracted position to a cutting position in which the cutting blade contacts and extends into the substrate, so that the treatment solution contacts the cutting blade, and then retract from the substrate. At least a portion of the treatment solution remains in contact with the cutting blade after the retraction.

Clause 2: The method of clause 1, further comprising, before inserting the substrate into the transport path, treating the substrate with the treatment solution by: (a) spraying the treatment solution on the substrate; (b) soaking the substrate in the treatment solution; or (c) applying the treatment solution to the substrate by a coating method.

Clause 3: The method of clause 1 or 2, wherein activating the printer causes the cutting blade to extend toward a cutting block of the printer, and when the cutting blade contacts and extends into the substrate, the cutting blade passes through a shield layer before the blade reaches the porous material.

Clause 4: The method of any preceding clause, further comprising activating the printer to cause the cutting blade to extend into the substrate and retract from the substrate more than one time.

Clause 5: The method of any preceding clause, further comprising activating the printer to cause the cutting blade to extend into the substrate and retract from the substrate a plurality of times at multiple locations on the substrate while the substrate moves along the transport path.

Clause 6: The method of any preceding clause, wherein the substrate comprises foam, polyethylene foam, polyurethane foam, cellulose tissue, non-cellulosic material, or felt.

Clause 7: The method of any preceding clause, wherein the treatment solution comprises a lubricant or anti-adhesive agent to reduce buildup on the cutting blade and cutting block.

Clause 8: The method of any preceding clause, wherein the treatment solution is free from silicone.

Clause 9: The method of any preceding clause, wherein the substrate is pre-saturated with the treatment solution and provided in a sealed pouch.

Clause 10: The method of any of clauses 1-8, wherein before use, the substrate and the treatment solution are packaged separately, and the method further includes applying the treatment solution to the substrate immediately before use.

Clause 11: The method of any preceding clause, wherein the substrate is positioned such that it contacts not only the cutting blade but also another part of the printer that comes into contact with adhesive residues.

Clause 12: The method of any preceding clause, wherein when the treatment solution contacts the cutting blade, the treatment solution forms a protective coating on the cutting blade.

Clause 13: The method of any preceding clause, wherein the substrate comprises a multi-layer structure, comprising a layer of the porous material to retain the treatment solution and a core layer to provide structural support during the cleaning method.

Clause 14: The method of any preceding clause, wherein the substrate further comprises a shield layer that envelops the porous material and retains the treatment solution in the porous material before the substrate is used. When the cutting blade extends into the substrate, the cutting blade does so by passing through an opening in the shield layer.

Clause 15: The method of any preceding clause, wherein the substrate comprises a multi-layer structure, comprising an abrasive layer to help remove residues from the cutting blade.

Clause 16: The method of any preceding clause, further comprising heating the substrate before insertion to enhance a cleaning effect of the treatment solution.

Clause 17: The method of any preceding clause, further comprising rotating the substrate within the transport path to expose various parts of the substrate to the cutting blade.

Clause 18: The method of any preceding clause, further comprising, before providing inserting the substrate into the transport path of the printer: (a) inserting an adhesive label material into the transport path of the printer to print a label; and (b) causing the cutting blade to cut the adhesive label material, wherein a residue from the adhesive label material remains on the adhesive label material after the cutting blade cuts the adhesive label material.

Clause 19: A method of treating a printer, the method comprising: (a) providing a first substrate comprising a porous material treated with a cleaning solution; (b) inserting the first substrate into a transport path of the printer; and (c) activating the printer. Activating the printer causes a cutting blade of the printer to: (i) extend from a retracted position to a cutting position in which the cutting blade contacts the first substrate, so that the cleaning solution contacts the cutting blade and cleans the cutting blade, and (ii) retract from the first substrate. The method then includes removing the first substrate from the transport path. The method then includes providing a second substrate treated with a treatment solution, inserting the second substrate into the transport path of the printer, and activating the printer a second time. Activating the printer for the second time causes the cutting blade to extend from the retracted position to the cutting position in which the cutting blade contacts the second substrate, so that the treatment solution contacts the cutting blade to form a protective coating on the cutting blade. The cutting blade will then retract from the second substrate. At least a portion of the treatment solution remains in contact with the cutting blade after this retraction.

Clause 20: The method of clause 19, wherein the cleaning solution and the treatment solution are the same solution.

Clause 21: The method of clause 19, wherein the cleaning solution and the treatment solution are different solutions.

Clause 22: A printer cleaning tool, comprising (a) a first substrate that comprises a core layer, and (b) a cleaning material layer that comprises a porous material, which is attached to the core layer, and that contains a treatment solution.

Clause 23: The cleaning tool of clause 22, wherein the first substrate also comprises a shield layer that is attached to the core layer, which comprises a non-porous material, and that retains the treatment solution in the cleaning material layer.

Clause 24: The cleaning tool of clause 23, wherein the shield layer comprises a pre-punctured section that is positioned at a location where the first substrate will receive a cutting blade of a print device when the first substate is placed into the print device.

Clause 25: The cleaning tool of any preceding clause, wherein the treatment solution comprises a cleaning solution, and wherein the tool further comprises a second substrate that comprises: (a) a core layer, and (b) a cleaning material layer that comprises a porous material, that is attached to the core layer of the second substrate, and that contains a coating solution.

Clause 26: The cleaning tool of clause 25, wherein the second substrate also comprises a shield layer that (a) is attached to the core layer of the second substrate, (b) comprises a non-porous material, and (c) retains the coating solution in the cleaning material layer of the second substrate.

Clause 27: The cleaning tool of clause 26, wherein the shield layer of the second substrate also comprises a pre-punctured section that is positioned at a location where the second substrate will receive the cutting blade of the print device when the second substate is placed into the print device.

The scope of the claims should not be limited by the specific embodiments set forth in the examples and the figures but should be given the broadest interpretation consistent with the description as a whole. Various modifications, adaptations, and alternative implementations may be made by combining various features of this disclosure without departing from the scope and spirit of the invention.

It should be understood that the method and apparatus described herein are not limited to the specific forms or arrangements of parts described and illustrated. Various changes and modifications may be made within the scope of the invention. For example, the cleaning and/or treatment solution compositions, the materials used for the substrate, and the specific configurations of the cutting mechanisms can all be varied to suit particular requirements and environments. The invention encompasses all alternative, modified, and equivalent methods and systems as they fall within the spirit and scope of the following claims.

1. A method of cleaning cutting elements of a printer, the method comprising:
providing a substrate comprising a porous material treated with a treatment solution, wherein the treatment solution comprises a cleaning and/or coating solution;
inserting the substrate into a transport path of a printer; and
activating the printer to cause a cutting blade of the printer to:
extend from a retracted position to a cutting position in which the cutting blade contacts and extends into the substrate, so that the treatment solution contacts the cutting blade, and
retract from the substrate,
wherein at least a portion of the treatment solution remains in contact with the cutting blade after the retraction.

2. The method of claim 1, further comprising, before inserting the substrate into the transport path, treating the substrate with the treatment solution by:
spraying the treatment solution on the substrate;
soaking the substrate in the treatment solution; or
applying the treatment solution to the substrate by a coating method.

3. The method of claim 1, wherein:
activating the printer causes the cutting blade to extend toward a cutting block of the printer; and
when the cutting blade contacts and extends into the substrate, the cutting blade passes through a shield layer before the blade reaches the porous material.

4. The method of claim 1, further comprising activating the printer to cause the cutting blade to extend into the substrate and retract from the substrate more than one time.

5. The method of claim 1, further comprising activating the printer to cause the cutting blade to extend into the substrate and retract from the substrate a plurality of times at multiple locations on the substrate while the substrate moves along the transport path.

6. The method of claim 1, wherein the substrate comprises foam, polyethylene foam, polyurethane foam, cellulose tissue, non-cellulosic material, or felt.

7. The method of claim 1, wherein the treatment solution comprises a lubricant or anti-adhesive agent to reduce buildup on the cutting blade and cutting block.

8. The method of claim 1, wherein the treatment solution is free from silicone.

9. The method of claim 1, wherein the substrate is pre-saturated with the treatment solution and provided in a sealed pouch.

10. The method of claim 1, wherein before use, the substrate and the treatment solution are packaged separately, and the method further includes applying the treatment solution to the substrate immediately before use.

11. The method of claim 1, wherein the substrate is positioned such that it contacts not only the cutting blade but also another part of the printer that comes into contact with adhesive residues.

12. The method of claim 1, wherein when the treatment solution contacts the cutting blade, the treatment solution forms a protective coating on the cutting blade.

13. The method of claim 1, wherein the substrate comprises a multi-layer structure, comprising a layer of the porous material to retain the treatment solution and a core layer to provide structural support during the cleaning method.

14. The method of claim 1, wherein:
the substrate further comprises a shield layer that envelops the porous material and retains the treatment solution in the porous material before the substrate is used; and
when the cutting blade extends into the substrate, the cutting blade does so by passing through an opening in the shield layer.

15. The method of claim 1, wherein the substrate comprises a multi-layer structure, comprising an abrasive layer to help remove residues from the cutting blade.

16. The method of claim 1, further comprising heating the substrate before insertion to enhance a cleaning effect of the treatment solution.

17. The method of claim 1, further comprising rotating the substrate within the transport path to expose various parts of the substrate to the cutting blade.

18. The method of claim 1, further comprising, before providing inserting the substrate into the transport path of the printer:
inserting an adhesive label material into the transport path of the printer to print a label; and
causing the cutting blade to cut the adhesive label material,
wherein a residue from the adhesive label material remains on the adhesive label material after the cutting blade cuts the adhesive label material.

19. A method of treating a printer, the method comprising:
providing a first substrate comprising a porous material treated with a cleaning solution;
inserting the first substrate into a transport path of the printer;
activating the printer to cause a cutting blade to:
extend from a retracted position to a cutting position in which the cutting blade contacts the first substrate, so that the cleaning solution contacts the cutting blade and cleans the cutting blade, and
retract from the first substrate;
removing the first substrate from the transport path;
providing a second substrate treated with a treatment solution;
inserting the second substrate into the transport path of the printer; and
activating the printer to cause the cutting blade to:
extend from the retracted position to the cutting position in which the cutting blade contacts the second substrate, so that the treatment solution contacts the cutting blade to form a protective coating on the cutting blade, and
retract from the second substrate;
wherein at least a portion of the treatment solution remains in contact with the cutting blade after the retraction from the second substrate.

20. The method of claim 19, wherein the cleaning solution and the treatment solution are the same solution.

21. The method of claim 19, wherein the cleaning solution and the treatment solution are different solutions.
